(19) United States
(12) Patent Application Publication
(10) Pub. No.: US 2006/0233201 A1
(43) Pub. Date: Oct. 19, 2006

(54) Adaptive encoding of digital multimedia information

(76) Inventor: Hartmut Wiesenthal, Fremont, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/539,547

(22) PCT Filed: Dec. 18, 2003
(86) PCT No.: PCT/IB03/06035

§ 371 Date: May 15, 2006

Related U.S. Application Data
(60) Provisional application No. 60/434,546, filed on Dec. 18, 2002.

(51) Int. Cl. H04J 3/18

(52) U.S. Cl. 370/477

(57) ABSTRACT

Adaptive encoding of digital multimedia information may be performed by measuring link parameters, such as a received signal strength, a bit error rate, or a rate of received acknowledgement signals, in order to determine an available transmission rate. A maximum encoding rate may then be determined based on the available transmission rate by, for example, dividing the available transmission rate by an overhead factor. If the encoding rate of the digital multimedia information exceeds the calculated maximum encoding rate, adaptive encoding of the digital multimedia information may be performed in order to conform the encoding rate of the digital multimedia information to the calculated maximum encoding rate. This process may involve compressing selected frames within a frame sequence, deleting high frequency components within selected frames, deleting I-frame components within selected frames, or mapping values within selected frames to corresponding values having coarser quantization.

The present invention generally relates to network communication systems, and more particularly, to systems and methods for adaptive encoding of digital multimedia information communicated over a network communication system.

Communicating digital multimedia information, such as audio or video, over a wireless or other bandwidth constrained network poses unique problems that must be overcome in order to satisfy the ever-increasing expectations of multimedia consumers. Because digital multimedia information typically involves time-sensitive information that is streamed to the receiving device, the rate at which the digital multimedia information is encoded must strictly conform with the available transmission rate of the communication channel. If the encoding rate of the digital multimedia information exceeds the available transmission rate, users may experience a severe degradation in the quality of the underlying application or the underlying application may prematurely terminate the communication session.

To meet the foregoing requirements, many data formatting standards, such as MPEG-1 or MPEG-4 for video and MPEG-1, layer III for audio, compress digital multimedia information so that the required transmission rate for the compressed information conforms with a predefined target transmission rate. These data formatting standards, however, typically fail to take into consideration the overhead added by the underlying network communication protocol, which can often reduce the effective transmission rate of the communication channel by a factor of three (e.g., two-thirds of the data transmitted may constitute overhead and control information). Furthermore, for applications that stream digital multimedia information from a first network, such as the Internet, and re-transmit the information over a second network, such as the user's home network, the original encoder may be unaware of overhead added by the second network. This failure to take into consideration the overhead of the underlying communication protocol may cause the digital multimedia information to be encoded at a higher rate than the underlying communication channel can support.

These problems may be further exacerbated due to the fluctuations in the available transmission rate that are commonly associated with many communication networks. For example, the available transmission rate of wireless communication channels may fluctuate due to such factors as the distance between the transmitting and receiving devices, obstructions between the transmitting and receiving devices, temporary decreases in the quality of the wireless channel due to environmental noise, or competition among applications sharing the same bandwidth. Because these fluctuations are difficult to predict and may occur several times during a lengthy communication session, there is a significant probability that these fluctuations will cause the encoding rate of the digital multimedia information to exceed the available transmission rate. Although it would be desirable to simply improve the transmission rate of the communication channel by, for example, increasing the transmission power, these approaches may not be available due to strict governmental regulations. As a result, providing mechanisms capable of efficiently compensating for fluctuations in the available transmission rate has proven to be a persistent problem.

Therefore, in light of the foregoing problems, there is a need for systems and methods that adaptively encode digital multimedia information to efficiently conform the encoding rate to the available transmission rate.

Embodiments of the present invention alleviate many of the foregoing problems by providing systems and method for adaptive encoding of digital multimedia information. In one embodiment, link parameters, such as a received signal strength, a bit error rate, or a rate of received acknowledgement signals, are measured in order to determine an available transmission rate. A maximum encoding rate may then be calculated based on the available transmission by, for example, dividing the available transmission rate by a predetermined overhead factor. If the encoding rate of the digital multimedia information exceeds the calculated maximum encoding rate, the digital multimedia information is adaptively encoded to conform the encoding rate of the digital multimedia information to the calculated maximum encoding rate.

Other embodiments provide various mechanisms that may be used to efficiently conform the encoding rate of the digital multimedia information to the available transmission rate. In one embodiment, for example, digital multimedia information may be adaptively encoded by compressing the digital multimedia information such that the required transmission rate of the compressed digital multimedia information is less than the calculated maximum encoding rate. In another embodiment, selected frames of the digital multimedia information may be compressed such that an average required transmission rate for the frame sequence is less than the calculated maximum encoding rate. This embodiment may advantageously use a higher level of compression for frames having a lower entropy than for frames having a higher entropy in order preserve the perceptual quality of the compressed information. Furthermore, the foregoing embodiments may efficiently reduce the amount of data that must be transmitted by, for example, deleting higher frequency components within selected frames, deleting I-frame components within selected frames, or mapping values within selected frames to corresponding values having a coarser quantization.

For applications where the digital multimedia information comprises a sequence of frames that are compressed at a first compression ratio, another embodiment of the present invention may adaptively encode the multimedia information by decimating a first set of frames within the frame sequence such that an average required transmission rate for the first frame sequence is less than the calculated maximum encoding rate. This process may involve deleting higher frequency components within the first set of frames, deleting I-frame components within the first set of frames, or mapping values within the first set of frames to corresponding values having a coarser quantization. A second set of frames within the frame sequence may then be decompressed and re-compressed at a second compression ratio such that the required transmission rate for the second set of frames is less than the calculated maximum encoding rate.

By ensuring that the encoding rate of the digital multimedia information conforms with the available transmission rate, embodiments of the present invention reduce or avoid the problems associated with existing approaches. Other embodiments further provide mechanisms that advantageously reduce the computational requirements that would otherwise be necessary to transition from a higher encoding rate to a lower encoding rate. As a result, embodiments of the present invention can provide a robust connection for streaming digital multimedia information over wireless or other bandwidth constrained networks, where the quality of the digital multimedia information can be adjusted to conform with the available transmission rate.

These and other features and advantage of the present invention will become more apparent to those skilled in the art from the following detailed description in conjunction with the appended drawings in which:

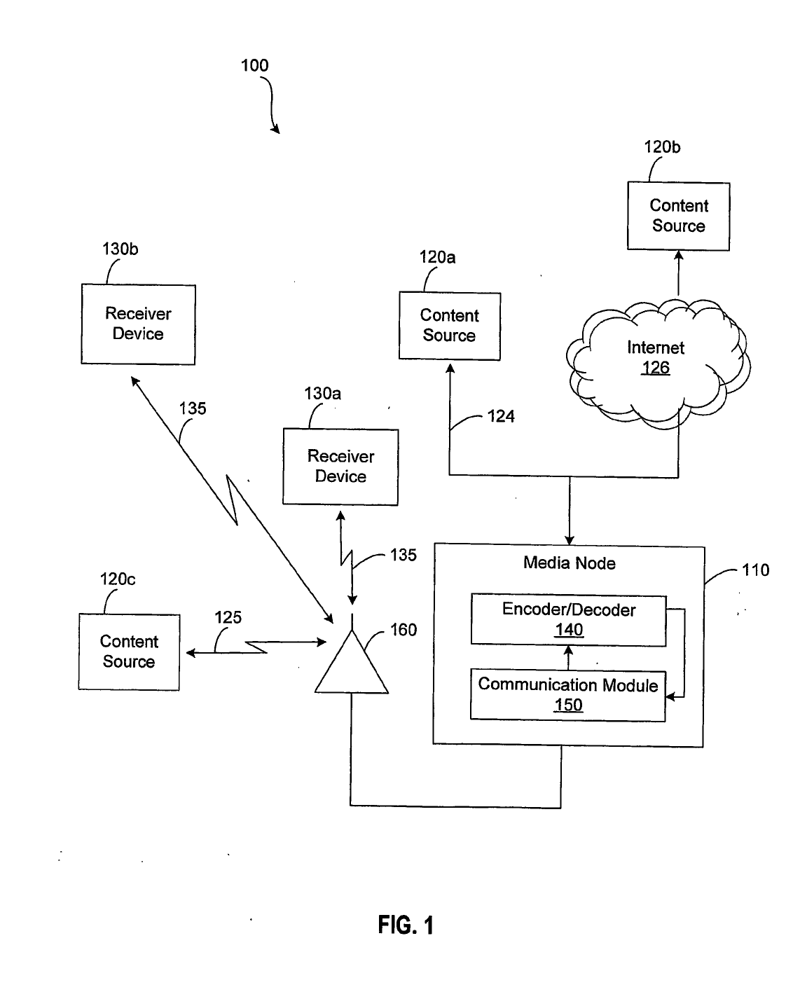

FIG. 1 illustrates a block diagram of an exemplary system in which the principles of the present invention may be advantageously practiced;

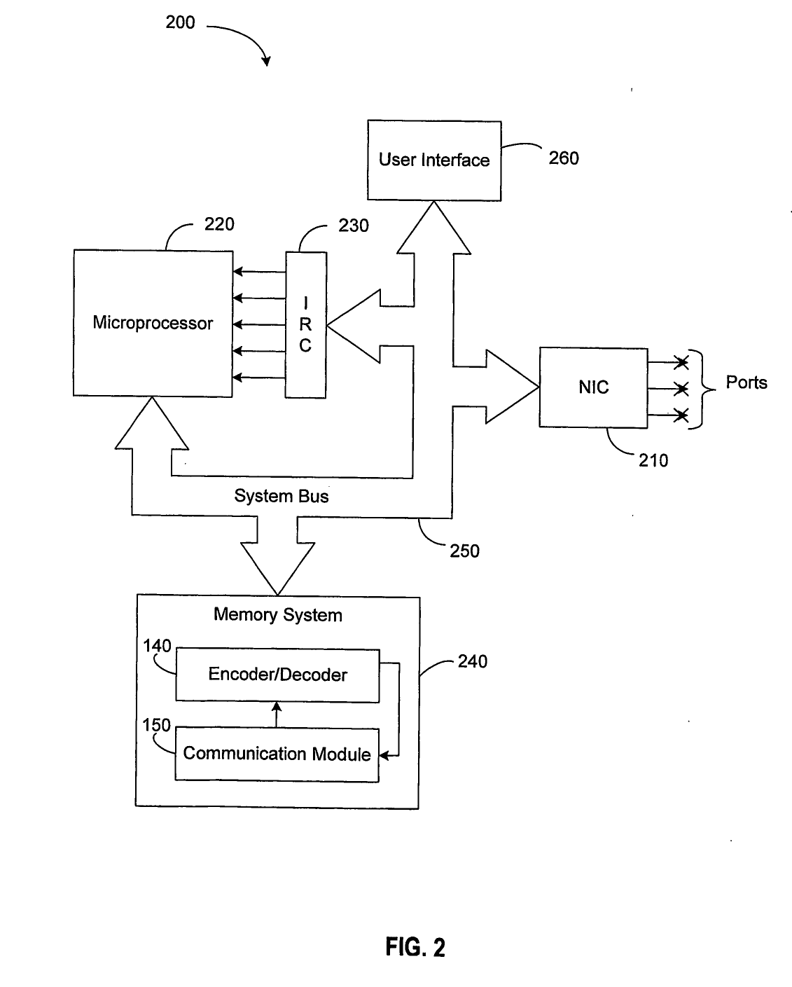

FIG. 2 illustrates an exemplary platform that may be used in accordance with embodiments of the present invention;

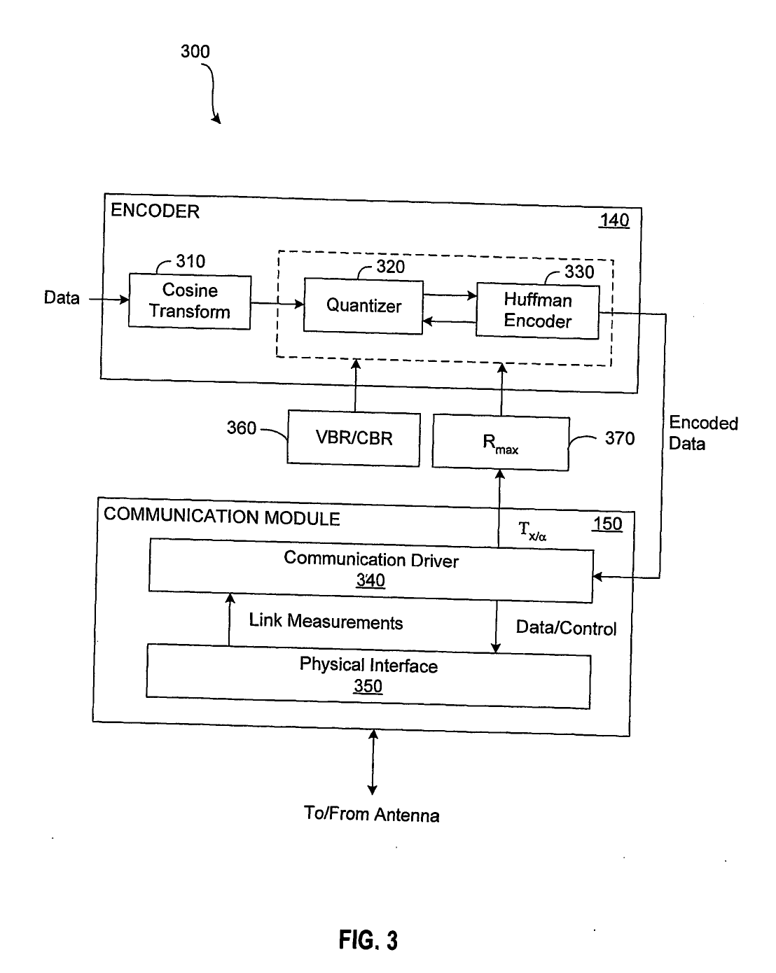

FIG. 3 illustrates a block diagram of an exemplary encoder and communication module in accordance with one embodiment of the present invention; and

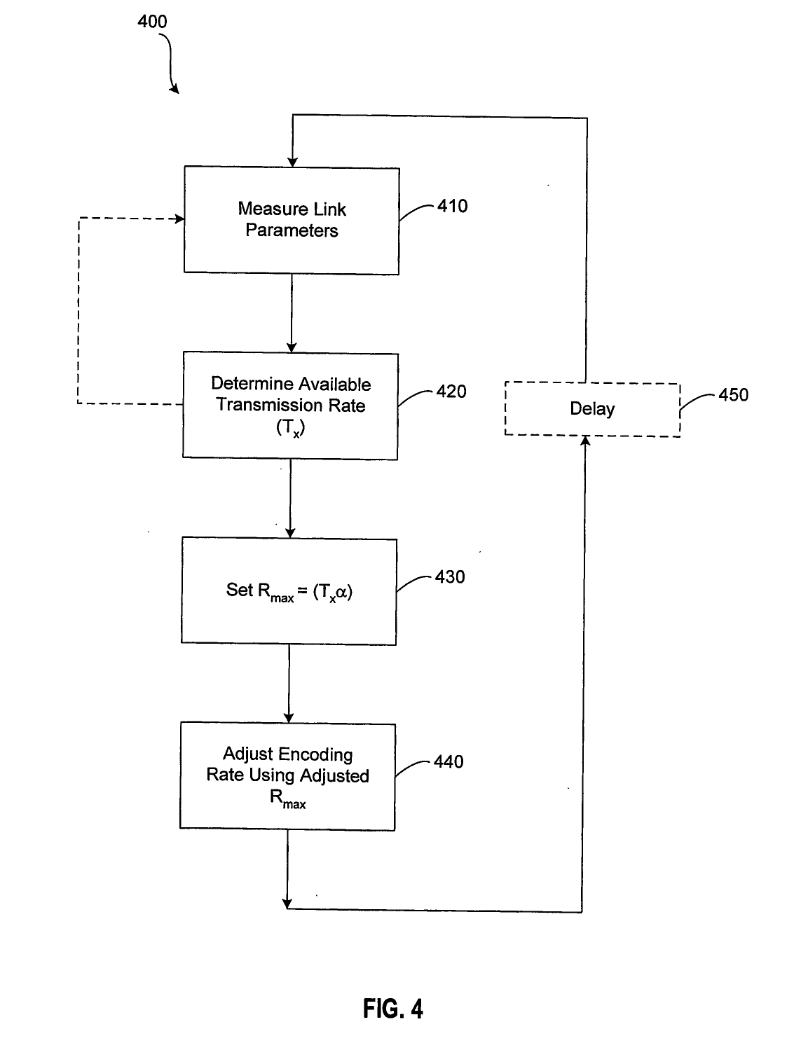

FIG. 4 illustrates an exemplary method in flowchart form for adaptive encoding of digital multimedia information in accordance with one embodiment of the present invention.

Embodiments of the present invention provide systems and methods for adaptive encoding of digital multimedia information. The following description is presented to enable a person skilled in the art to make and use the invention. Descriptions of specific applications are provided only as examples. Various modifications, substitutions and variations of the preferred embodiment will be readily apparent to those skilled in the art, and the generic principles defined herein may be applied to other embodiments and applications without departing from the scope of the invention. Thus, the present invention is not intended to be limited to the described and illustrated embodiments, and should be accorded the widest scope consistent with the principles and features disclosed herein.

Referring to FIG. 1, a block diagram of an exemplary system in which the principles of the present invention may be advantageously practiced is illustrated generally at 100. As illustrated, the exemplary system includes a media node 110 that connects one or more content sources 120, such as a computer system, VCR, DVD player, CD player or other device that stores digital multimedia information, with one or more receiving devices 130, such a computer monitor, television, speaker system or other device that plays or displays digital multimedia information. Each content source 120 may be connected to the media node 110 via a wired connection 124, a wireless connection 125 or through a network connection, such as the Internet 126. Although each receiving device 130 may be connected to the media node 110 using similar types of connections, the embodiment of FIG. 1 utilizes wireless connections 135 in order to avoid the need to install and maintain expensive and cumbersome wiring between the media node 110 and each receiving device 130. However, because the available transmission rate of each wireless connection 135 is largely determined by such factors as the distance between the receiving device 130 and the antenna 160, obstructions between the receiving device 130 and the antenna 160, temporary decreases in the quality of the wireless channel 135 due to environmental noise, or competition among applications sharing the same bandwidth, the instantaneous available transmission rate of each wireless connection 135 may experience fluctuations during the communication session.

In order to alleviate the problems associated with a mismatch between the encoding rate of the digital multimedia information and the available transmission rate of the wireless connection 135, the media node 110 may be configured to adaptively encode digital multimedia information received from a content source 120 so that the required transmission rate of the digital multimedia information conforms with the available transmission rate of the receiving device 130. In this context, a communication module 150 within the media node 110 may be configured to measure link parameters associated with the wireless connection 135, such as a received signal strength, a bit error rate, or a rate of received acknowledgement signals, in order to determine an available transmission rate. The encoder/decoder 140 may then utilize the available transmission rate to calculate a maximum encoding rate by, for example, dividing the available transmission rate by an overhead factor associated with the underlying network communication protocol. If the encoding rate of the digital multimedia information exceeds the calculated maximum encoding rate, the encoder/decoder 140 adaptively encodes the digital multimedia information to conform the encoding rate of the digital multimedia information to the calculated maximum encoding rate.

Notably, the encoder/decoder 130 may employ various mechanisms to efficiently conform the encoding rate of the digital multimedia information to the available transmission rate. In one embodiment, for example, digital multimedia information may be adaptively encoded by compressing the digital multimedia information such that the required transmission rate of the compressed digital multimedia information is less than the calculated maximum encoding rate. In another embodiment, selected frames of the digital multimedia information may be compressed such that an average required transmission rate for the frame sequence is less than the calculated maximum encoding rate. This embodiment may advantageously use a higher level of compression for frames having a lower entropy than for frames having a higher entropy in order preserve the perceptual quality of the compressed information. The communication module 150 may also be configured to reduce the amount of data that must be transmitted by, for example, deleting higher frequency components within selected frames, deleting I-frame components within selected frames, or mapping values within selected frames to corresponding values having a coarser quantization. This embodiment may be used alone or in combination with the embodiments described above with respect to the encoder/decoder 140 to reduce the computational requirements of the encoder/decoder 130 or enable the encoder/decoder 140 to smoothly transition to a lower encoding rate.

For applications where the digital multimedia information comprises a sequence of frames that are compressed at a first compression ratio (e.g., where the digital multimedia information is stored at a content source 120 in compressed form or received from a remote content source 120 via an Internet connection 126), the communication module 150 may be configured to decimate a first set of frames within the frame sequence such that an average required transmission rate for the first frame sequence is less than the calculated maximum encoding rate. This process may involve deleting higher frequency components within the first set of frames, deleting I-frame components within the first set of frames, or mapping values within the first set of frames to corresponding values having a coarser quantization. A second set of frames within the frame sequence may then be decompressed and re-compressed by the encoder/decoder 140 at a second compression ratio such that the required transmission rate for the second set of frames is less than the calculated maximum encoding rate.

By ensuring that the encoding rate of the digital multimedia information conforms with the available transmission rate, embodiments of the present invention reduce or avoid the problems associated with existing approaches. Other embodiments further provide mechanisms that advantageously reduce the computational requirements that would otherwise be necessary to transition from a higher encoding rate to a lower encoding rate. As a result, embodiments of the present invention can provide a robust connection for streaming digital multimedia information over wireless or other bandwidth constrained networks, where the quality of the digital multimedia information can be adjusted to conform with the available transmission rate.

Referring to FIG. 2, an exemplary platform that may be used in accordance with embodiments of the present invention is illustrated generally at 200. As illustrated, the exemplary platform includes a network interface card 210 for interfacing with other nodes within the network, such as content sources, receiving devices, antennas, gateways, etc. The network interface card 210 may be coupled to a processor via a system bus 250. The processor may also be coupled to a memory system 240, such as a random access memory, a hard drive, floppy drive, a compact disk, or other computer readable medium, that stores code for the encoder/decoder 140 and communication module 150. The exemplary platform may also include a management interface 260, such as a keyboard, input device or communication port, which may be used to selectively modify configuration parameters for the encoder/decoder 140 or communication module 150 without requiring the underlying code to be recompiled.

In operation, the processor 220 may be configured to respond to interrupts from an associated interrupt controller 230 in accordance with the interrupt's assigned priority. These interrupts may cause the processor 220 to execute computer code stored within the memory system 240. For example, interrupts may cause the processor 220 to periodically call the communication module 150 in order to measure link parameters associated with a particular wireless connection, determine an available transmission rate for the connection, adjust the transmission power or modulation scheme associated with the connection, transmit digital multimedia information received from the encoder/decoder 140 to the intended receiving device, or decimate selected frames of encoded multimedia information. The processor 220 may also call the encoder/decoder 140 to periodically retrieve the updated transmission rate determined by the communication module 150, calculate a maximum encoding rate for the digital multimedia information, or encode (or decode and re-encode) the digital multimedia information so that the encoding rate of the digital multimedia information conforms with the calculated maximum encoding rate.

Referring to FIG. 3, a block diagram of an exemplary encoder and communication module in accordance with one embodiment of the present invention is illustrated generally at 300. As illustrated, the encoder 140 includes a cosine transformation unit 210, a quantizer 320 and a Huffman encoder 330 that may be used to encode (or compress) digital multimedia information in accordance with a lossy compression algorithm, such as MPEG-1, MPEG-4 or MPEG-1, layer III. The cosine transformation unit 320 may be used to partition received data into a number of frames and then convert the data within each frame into its corresponding frequency coefficients. The frequency coefficients are then applied to a quantizer 320 and Huffman encoder 330, which iteratively quantize and Huffman encode the frequency coefficients until the resulting encoded data conforms with the target variable bit rate/constant bit rate parameters (VBR/CBR) 360 and the maximum encoding rate parameter (Rmax) 370. The VBR/CBR parameter 360 may be initialized by the user or the underlying multimedia application. The Rmax parameter 370 sets an upper limit on the encoding rate and overrides the values set by the VBR/CBR parameters 360. As will be discussed in greater detail below, the Rmax parameter 370 may also be periodically updated based on the available transmission rate (Tx) determined by the communication module 150 (e.g., by dividing Tx by a predetermined overhead factor associated with the communication protocol).

In operation, the encoder 140 may use Rmax to set the maximum encoding rate for each frame of multimedia information. If a given frame of multimedia information exceeds the value of Rmax, the encoder 140 may cause the quantizer 320 to use a higher scale factor or cause the Huffman encoder 330 to use a Huffman table having a coarser quantization until the encoding rate of the frame fails below Rmax. This embodiment provides advantages in that it ensures that no frame exceeds the value of Rmax. In an alternative embodiment, the encoder 140 may encode selected frames of multimedia information such that the average encoding rate for the frame sequence is less than Rmax. For example, if Rmax has a current value of 2 Mbits/s, the encoder 140 may encode the first two frames in the frame sequence at a rate of 1 Mbits/s and the third frame in the frame sequence at a rate of 3 Mbits/s. This alternative embodiment may be advantageous in that it enables the encoder 140 to allocate higher encoding rates (or lower compression ratios) to frames having a higher entropy than to frames having a lower entropy, thereby enabling the encoder 140 to maximize the perceptual quality of the encoded information.

Once the encoder 140 has encoded each frame, the frames are passed to the communication module 150 for transmission. As illustrated in FIG. 3, the communication module 150 includes a communication driver 340 that receives the encoded multimedia information from the encoder 140, adds the appropriate header information to each frame and passes the formatted data to a physical interface 350. The physical interface 350 then modulates the formatted data and sends the data to the antenna for transmission.

The physical layer 350 also measures link parameters associated with the wireless connection, such as a received signal strength, a bit error rate or a rate of received acknowledgement signals, and passes the measured parameters back to the communication driver 340. The communication driver 340 then uses the measured parameters to determine an available transmission rate (Tx) for the wireless connection. This process may advantageously exploit the algorithms utilized by many network communication protocols, such as IEEE 802.11a or IEEE 802.11b, that dynamically switch between allowable transmission rates in response to the measured link parameters reaching certain predefined thresholds. If the available transmission rate has changed, the communication driver 340 communicates the new transmission rate (Tx) to the encoder 140 so that the encoder 140 can adjust the value of Rmax. The communication driver 340 will also pass control parameters to the physical layer 350 to adjust the transmission power levels and associated modulation scheme to implement the new transmission rate.

Because the encoder 140 may have previously encoded frames using the old Rmax and stored these frames in a transmission buffer, the communication driver 340 may also be configured to decimate the buffered frames in order to conform the decimated frames with the new available transmission rate and enable the encoder 140 to smoothly transition to the new Rmax. For example, many data formatting standards, such as MPEG-1, MPEG-4 and MPEG-1, layer III, arrange frequency coefficients within each frame from highest to lowest frequency. By deleting high frequency code words at the end of each frame until the required transmission rate of the frame (or the average required transmission rate for a sequence of frames) is less than the available transmission rate, the communication driver 340 can conform the encoding rate of the digital multimedia information to the available transmission rate with a relatively small increase in computational complexity. This process essentially reduces the required transmission rate for the buffered frames by filtering high frequency components, which may have a less perceptible impact on the overall quality of the resulting data.

An alternative embodiment may configure the communication driver 340 to map the Huffman code words within each frame to corresponding Huffman code words having coarser quantization. Because the Huffman tables used in MPEG-related standards are well known and provide a predicted compression ratio for each table, the communication driver 340 can efficiently select the Huffman table having the desired compression ratio and efficiently map the code words within each frame to corresponding code words with the selected Huffman table using a predefined mapping relationship. Furthermore, if the required transmission rate of the frame still exceeds the available transmission rate after the mapping is performed, the communication driver 340 may delete high frequency code words as discussed above until the required transmission rate of the frame (or the average required transmission rate for a sequence of frames) is less than the available transmission rate. This embodiment may be advantageous in that it retains some high frequency information within each frame, albeit at the expense of a lower resolution for other frequency components.

Yet another embodiment exploits the fact that I-frame components are generally considered less important than B-frame components in terms of the perceptual quality of the MPEG-encoded video. Accordingly, the communication driver 340 may be configured to delete I-frame components within buffered frames until the required transmission rate of the frame (or the average required transmission rate for a sequence of frames) is less than the available transmission rate.

If the digital multimedia information is already compressed at a first compression ratio (e.g., because the information was stored at the content source in compressed form), still another embodiment may configure the communication driver 340 to decimate a first set of frames within the frame sequence using one of the embodiments described above until the average required transmission rate for a sequence of frames is less than the available transmission rate. A second set of frames within the frame sequence may then be decoded using a decoder and re-encoded using the encoder 140 and updated Rmax as described above. By providing a mechanism to efficiently reduce the amount of data required to be transmitted for initial frames within the frame sequence, this embodiment may reduce the computational speed that would otherwise be required to decode and re-encode the entire data stream.

Referring to FIG. 4, an exemplary method in flowchart form for adaptive encoding of digital multimedia information in accordance with one embodiment of the present invention is illustrated generally at 400. As illustrated, the exemplary method may be initiated at step 410 by measuring link parameters, such as a received signal strength, a bit error rate or a rate of receive acknowledgement signals, that are associated with the communication link under examination. At step 420, the available transmission rate (Tx) of the communication link may be determined using the measured link parameters by, for example, selecting among allowable transmission rates based on whether the measured parameters reach predefined threshold values. A maximum encoding rate (Rmax) may then be determined at step 430 by dividing the available transmission rate by an overhead factor (a) associated with the relevant communication protocol. The adjusted Rmax may then be used at step 440 to adjust the encoding of the digital multimedia information to conform the encoding rate of the digital multimedia information to the adjusted Rmax. This adjusting process may utilize any of processes described above with respect to the embodiments of FIGS. 1-3. After step 440, the exemplary method then proceeds back to step 410 through an optional delay step 450 to allow the available transmission rate (Tx) to settle to a steady state.

While the present invention has been described with reference to exemplary embodiments, it will be readily apparent to those skilled in the art that the invention is not limited to the disclosed and illustrated embodiments but, on the contrary, is intended to cover numerous other modifications, substitutions and variations and broad equivalent arrangements that are included within the scope of the following claims.

1. A method for adaptive encoding of digital multimedia information, the method comprising: measuring link parameters associated with a communication link between a sender and a receiver determining an available transmission rate of the communication link based on the measured link parameters; calculating a maximum encoding rate of the digital multimedia information based on the available transmission rate; and if the encoding rate of the digital multimedia information exceeds the calculated maximum encoding rate, adapting the encoding of the digital multimedia information to conform the encoding rate of the digital multimedia information to the calculated maximum encoding rate.

2. The method of claim 1, wherein the step of measuring comprises measuring at least one of a received signal strength, a bit error rate and a rate of received acknowledgement signals.

3. The method of claim 1, wherein the step of calculating comprises dividing the available transmission rate by a predetermined overhead factor.

4. The method of claim 1, wherein the step of adapting comprises compressing the digital multimedia information such that the required transmission rate of the compressed digital multimedia information is less than the calculated maximum encoding rate.

5. The method of claim 1, wherein the digital multimedia information comprises a sequence of frames, and wherein step of adapting comprises compressing selected frames within the frame sequence such that an average required transmission rate for the frame sequence is less than the calculated maximum encoding rate.

6. The method of claim 5, wherein frames within the frame sequence having a lower entropy are compressed at a higher compression ratio than frames having a higher entropy.

7. The method of claim 5, wherein the step of compressing comprises deleting higher frequency components within the selected frames.

8. The method of claim 5, wherein the step of compressing comprises mapping values within the selected frames to corresponding values having a coarser quantization.

9. The method of claim 5, wherein frames within the frame sequence include I-frames and B-frames, and wherein the step of compressing comprises deleting the I-frames within the selected frames.

10. The method of claim 1, wherein the digital multimedia information comprises a sequence of frames compressed at a first compression ratio, and wherein the step of adapting comprises: deleting higher frequency components for a first set of frames within the frame sequence such that an average required transmission rate for the first frame sequence is less than the calculated maximum encoding rate; decompressing a second set of frames within the frame sequence; and re-compressing the second set of frames at a second compression ratio such that the required transmission rate of the re-compressed digital multimedia information is less than the calculated maximum encoding rate.

11. A system for adaptive encoding of digital multimedia information, the system comprising: a processor; and a memory unit operably coupled to the processor for storing instructions which when executed by the processor cause the processor to operate so as to: measure link parameters associated with a communication link between a sender and a receiver determine an available transmission rate of the communication link based on the measured link parameters; calculate a maximum encoding rate of the digital multimedia information based on the available transmission rate; and if the encoding rate of the digital multimedia information exceeds the calculated maximum encoding rate, adapt the encoding of the digital multimedia information to conform the encoding rate of the digital multimedia information to the calculated maximum encoding rate.

12. The system of claim 11, wherein the measured link parameters comprise at least one of a received signal strength, a bit error rate and a rate of received acknowledgement signals.

13. The system of claim 11, wherein the calculated maximum encoding rate comprises the available transmission rate divided by a predetermined overhead factor.

14. The system of claim 11, wherein adaptation of the encoding of the digital multimedia information is performed by compressing the digital multimedia information such that the required transmission rate of the compressed digital multimedia information is less than the calculated maximum encoding rate.

15. The system of claim 11, wherein the digital multimedia information comprises a sequence of frames, and wherein adaptation of the encoding of the digital multimedia information is performed by compressing selected frames within the frame sequence such that an average required transmission rate for the frame sequence is less than the calculated maximum encoding rate.

16. The system of claim 15, wherein frames within the frame sequence having a lower entropy are compressed at a higher compression ratio than frames having a higher entropy.

17. The system of claim 15, wherein the compression of the selected frames is performed by deleting higher frequency components within the selected frames.

18. The system of claim 15, wherein the compression of the selected frames is performed by mapping values within the selected frames to corresponding values having a coarser quantization.

19. The system of claim 15, wherein frames within the frame sequence include I-frames and B-frames, and wherein the compression of the selected frames is performed by deleting the I-frames within the selected frames.

20. The system of claim 11, wherein the digital multimedia information comprises a sequence of frames compressed at a first compression ratio, and wherein adaptation of the encoding of the digital multimedia information is performed by: deleting higher frequency components for a first set of frames within the frame sequence such that an average required transmission rate for the first frame sequence is less than the calculated maximum encoding rate; decompressing a second set of frames within the frame sequence; and re-compressing the second set of frames at a second compression ratio such that the required transmission rate of the re-compressed digital multimedia information is less than the calculated maximum encoding rate.
